(19) United States
(12) Patent Application Publication
(10) Pub. No.: US 2016/0216778 A1
(43) Pub. Date: Jul. 28, 2016

(54) INTERACTIVE PROJECTOR AND OPERATION METHOD THEREOF FOR DETERMINING DEPTH INFORMATION OF OBJECT

(71) Applicant: Industrial Technology Research Institute, Hsinchu (TW)

(72) Inventors: Chih-Hsiang Yu, Hsinchu County (TW); Shys-Fan Yang Mao, Hsinchu County (TW); Shih-Chieh Chen, Hsinchu City (TW)

(21) Appl. No.: 14/886,114

(22) Filed: Oct. 19, 2015

Related U.S. Application Data
(60) Provisional application No. 62/108,060, filed on Jan. 27, 2015.

(51) Int. Cl. G06F 3/03; G06F 3/00; G06T 7/00; G06F 3/01

(52) U.S. Cl. CPC G06F 3/0317; G06F 3/017; G06F 3/005; G06T 7/0057

(57) ABSTRACT

An interactive projector and an operation method thereof for determining a depth information of an object are provided. The interactive projector includes an optical engine, an image capture unit and a process unit is provided. The optical engine projects a visible image via a visible light source and an invisible pattern via an invisible light source to a projection area. The visible light source and the visible are integrated to the optical engine. The image capturing unit captures an image having depth information from the projection area, which the image is being projected on an object via the invisible light source. A processing unit is electrically coupled to the optical engine and the image capturing unit. The processing unit receives the image having depth information and determines an interactive event according to the image having depth information. According to the interactive event, a status of the optical engine is refreshed.

### CROSS-REFERENCE TO RELATED APPLICATION

This application claims the priority benefits of U.S. provisional application Ser. No. 62/108,060, filed on Jan. 27, 2015. The entirety of the above-mentioned patent application is hereby incorporated by reference herein and made a part of this specification.

### TECHNICAL FIELD

The disclosure relates to an interactive projector and an operation method thereof for determining a depth information of an object.

### BACKGROUND

In recent years, contact-free human-machine interfaces (cfHMIs) have been developed rapidly. At present, a number of manufacturers have been dedicated to creating various human-machine interaction devices to be applied in our daily lives. For instance, a combination of a depth camera Kinect and a projector is made by Microsoft to arrive at the application of an interactive projection. However, such design has problems of a high manufacturing cost and an over-sized volume in appearance. In addition, as an image alignment between the depth camera and the projector is still demonstrated as a product in an experimental stage, it is not yet applicable to a product. Hence, the use of the image alignment technology in the human-machine interaction devices confronts a lot of difficult and complicated issues in manufacturing process.

### SUMMARY OF THE DISCLOSURE

In accordance with the disclosure, embodiments of the present disclosure are directed to an interactive projector and an operation method thereof for determining a depth information of an object.

In an exemplary embodiment of the disclosure, the interactive projector that includes an optical engine, an image capture unit and a process unit is provided. The optical engine projects a visible image via a visible light source and an invisible pattern via an invisible light source to a projection area. Here, the visible light source and the visible are integrated to the optical engine. The image capturing unit captures an image having depth information from the projection area, in which the image is being projected on an object via the invisible light source. A processing unit is electrically coupled to the optical engine and the image capturing unit. The processing unit receives the image having depth information and determines an interactive event according to the image having depth information. According to the interactive event, a status of the optical engine is refreshed.

In another exemplary embodiment of the disclosure, the operation method of an interactive projector for determining a depth information of an object is provided, and the interactive projector includes an optical engine, an image capturing unit and a processing unit. The operation method includes following steps. An invisible light beam is projected onto a projection area by the optical engine, so as to form an invisible pattern. The invisible pattern is captured by the image capturing unit, and the invisible pattern is further stored as a reference pattern by the processing unit. The invisible light beam is projected on an object from the projection area by the optical engine, and so as to form an image having depth information of the object. The image having depth information of the object is captured by the image capturing unit. The reference pattern and the image having depth information of the object are compared by the processing unit, so as to obtain a depth information of the object.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating an interactive projector according to an embodiment of the disclosure.

FIG. 2 is a schematic diagram illustrating an optical engine according to an embodiment of the disclosure.

FIG. 3 is a schematic diagram illustrating an embodiment of a configuration of an optical engine depicted in FIG. 3.

FIG. 4 is a schematic diagram illustrating an optical engine according to another embodiment of the disclosure.

FIG. 5 is a schematic diagram illustrating an embodiment of a configuration of an optical engine depicted in FIG. 4.

FIG. 6 is a flowchart illustrating an operation method of an interactive projector for determining a depth information of an object according to an embodiment of the present disclosure.

FIG. 7 is a flowchart illustrating a method of capturing the image having depth information of the object according to an embodiment of the present disclosure.

### DETAILED DESCRIPTION OF DISCLOSED EMBODIMENTS

The disclosure will now be described with reference to the accompanying figures. It is to be understood that the specific illustrated in the attached figures and described in the following description is simply an exemplary embodiment of the present disclosure. This description is made for the purpose of illustrating the general principles of the disclosure and should not be taken in a limiting sense. The scope of the disclosure is best determined by reference to the appended claims

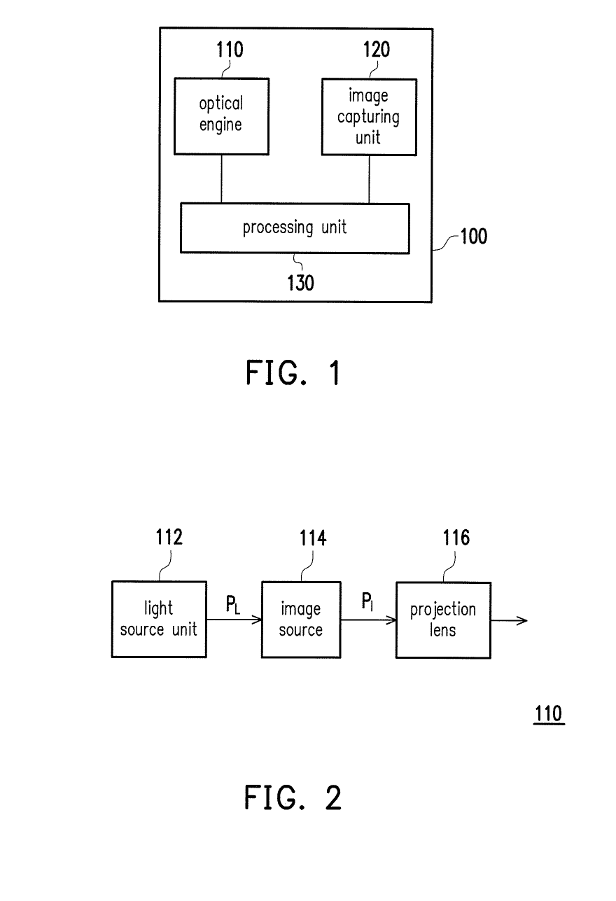

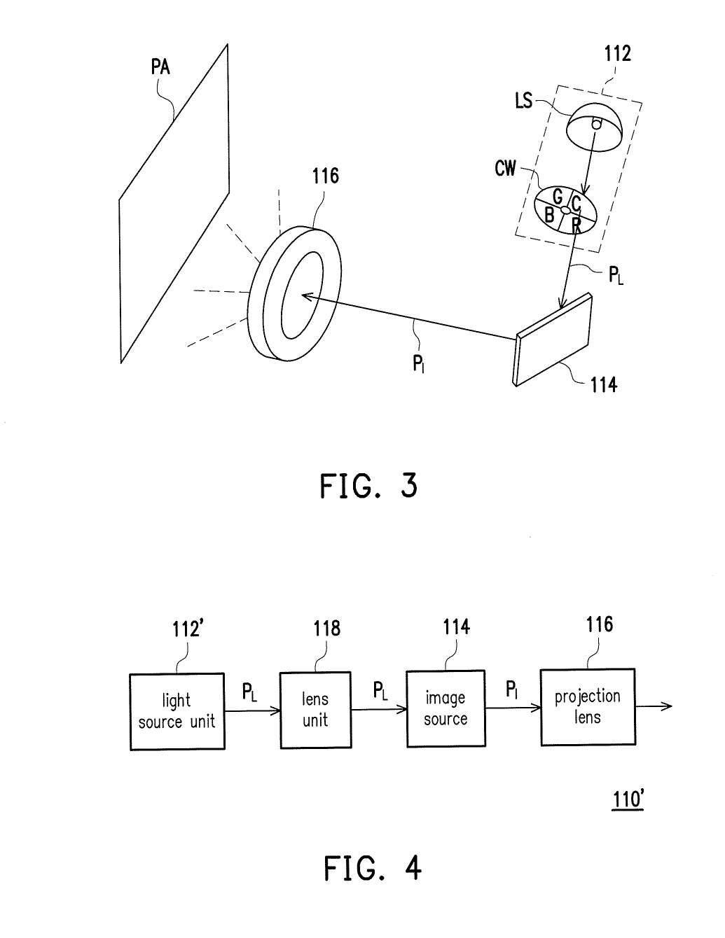

FIG. 1 is a schematic diagram illustrating an interactive projector according to an embodiment of the disclosure. FIG. 2 is a schematic diagram illustrating an optical engine according to an embodiment of the disclosure. FIG. 3 is a schematic diagram illustrating an embodiment of a configuration of an optical engine depicted in FIG. 3. As shown in FIG. 1, FIG. 2, and FIG. 3, an interactive projector 100 of the present embodiment includes an optical engine 110, an image capturing unit 120 and a process unit 130. The exemplary functions of these components are respectively described below.

The optical engine 110 includes a light source unit 112, an image source 114, and a projection lens 116. The light source unit 112 has a light source LS integrating both of a visible light source emitting a visible light and an invisible light source emitting an invisible light, such that the light source unit 112 provides a visible light beam and an invisible light beam simultaneously or periodically. In the embodiment, the visible light source, for example, includes a white light-emitting diode (LED), but the disclosure is not limited thereto. In other embodiments, the visible light source includes a red LED, a green LED and a blue LED. In the embodiment, the invisible light source, for example, includes an infrared ray (IR). In an embodiment, the light source unit 112 further comprises a color wheel, at least one mirror, at least one dichroic mirror, or a combination thereof, the disclosure is not limited thereto.

The image source 114 is located at light paths P_{L} of the visible light beam and the invisible light beam. As the visible light beam and the invisible light beam pass through the image source 114, the image source 114 converts the visible light beam into a visible image beam and converts the invisible light beam into an invisible image beam. In an embodiment, the image source 114, for example, includes a display panel.

The projection lens 116 is located at light paths P_{I} of the visible image beam and the invisible image beam. As the visible image beam and the invisible image beam pass through the projection lens 116, the projection lens 116 projects a visible image and an invisible pattern to a projection area PA located outside the optical engine 110.

In the embodiment, the light source unit 112 further includes a color wheel CW (refereeing to FIG. 3), where the color wheel CW has a red region R, a blue region B, a green region G, and a colorless region C. When the color wheel CW is rotated, the light source LS emits either the visible light or the invisible light in accordance with the rotation of the color wheel CW, so as to provide visible light beams with different color and an invisible light beam. When the visible light provided by the light source LS passes an region of a certain color on the color wheel CW, the visible light of other colors are filtered out, such that the visible light passing through the color wheel CW is transformed into a mono-color visible light corresponding to the color of the region. For example, when the color wheel is rotated to the red region, the visible light emitted by the light source LS is transformed into a visible light beam of red color after passing through the color wheel CW. For another example, when the color wheel is rotated to the colorless region, the invisible light emitted by the light source LS is not transformed and passing through the color wheel CW as the invisible light beam. Moreover, the light paths P_{L} of the visible light beam and the invisible light beam provided by the light source unit 112 share the same transmission path.

With the use of a rotating color wheel, the visible light emitted by the light source LS (e.g., the white LED) is splitted into a visible light beam having mono-color, such as a red visible light beam, a green visible light beam and a blue visible light beam. Then, these of the red visible light beam, the green visible light beam and the blue visible light beam are then projected to the image source 114 to form corresponding visible image beams, and then are projected to the projection area PA through the projection lens 116, so as to present a color projection frame, i.e., the visible image. In an embodiment, the visible image can be, for example, an user operation interface. In addition, the invisible light emitted by the light source LS (e.g., the IR) is passing through the color wheel CW as the invisible light beam. Then, the invisible light beam is projected to the image source 114 to form a corresponding invisible image beams, and which are projected to the projection area PA through the projection lens 116, so as to form the invisible pattern.

The image capturing unit 120 captures an image having depth information from the projection area, in which the image having depth information is generated when the invisible image beam is projected onto an object from the projection area PA. Furthermore, before the image capturing unit 120 captures the image having depth information, the image capture unit 120 first captures a reference pattern, which the reference pattern is the invisible pattern which is generated by projecting invisible image beam to the projection area PA. In an embodiment, the image capturing unit 120 can be, for example, a depth camera, a 3D camera having a multiple lenses, a combination of multiple cameras for constructing a three-dimensional (3D) image, or other image sensors capable of detecting 3D space information.

The processing unit 130 is electrically coupled to the optical engine 110 and the image capturing unit 120. The processing unit 130 receives the image having depth information and compares the reference pattern and the image having depth information to obtain a depth information of the object. According to the depth information of the object obtained from the image having depth information, the processing unit 130 determines an interactive event. In other words, the processing unit 130 performs image process and analysis for the image having depth information of the object, so as to detect a region of the object, and the processing unit 130 determines the interactive event according to the region of the object. Then, a status of the optical engine 110 is refreshed according to the interactive event. For example, the visible image projected by the optical engine 110 is updated according to the interactive event. The processing unit 130 is, for example, a device such as a central processing unit (CPU), a graphics processing unit (GPU), or other programmable microprocessor.

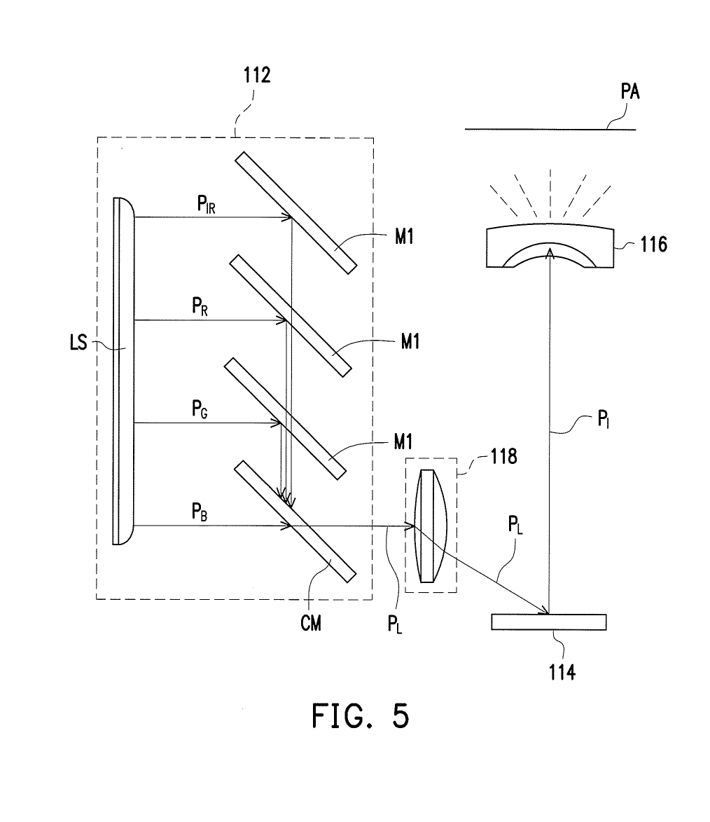

FIG. 4 is a schematic diagram illustrating an optical engine according to another embodiment of the disclosure. FIG. 5 is a schematic diagram illustrating an embodiment of a configuration of an optical engine depicted in FIG. 4. Referring to FIGS. 2-3 and FIGS. 4-5 together, the optical engine 110′ of FIG. 4 and the optical engine 110 of FIG. 2 are similar, the differences are that, the optical engine 110′ of FIG. 4 includes a light source unit 112′ to replace the light source unit 112 of FIG. 2 and further includes a lens unit 118.

Referring to FIG. 1, FIG. 4, and FIG. 5 together, the interactive projector 100 of the present embodiment includes an optical engine 110′, an image capturing unit 120 and a process unit 130. The optical engine 110′ includes a light source unit 112′, an image source 114, a projection lens 116 and a lens unit 118. The exemplary functions of these components are respectively described below.

The light source unit 112′ has a light source LS integrating both of a visible light source emitting a visible light and an invisible light source emitting an invisible light, such that the light source unit 112′ provides a visible light beam and an invisible light beam simultaneously or periodically. In the embodiment, the visible light source includes a red LED, a green LED and a blue LED. In the embodiment, the invisible light source, for example, includes an IR.

In the embodiment, the light source unit 112′ further includes at least one mirror M1-M3 and at least one dichroic mirror DM. As shown in FIG. 5, the red LED, the blue LED, the green LED and the IR integrated in the light source LS respectively emits a red light having a light path P_{R}, a green light having a light path P_{G}, a blue light having a light path P_{B} and an invisible light having a light path P_{IR}. Since these light paths (e.g., P_{R}, P_{G}, P_{B}, P_{IR}) are not at the same transmission path, the mirrors M1-M3 and the dichroic mirror DM are used to adjust the light paths (e.g., P_{R}, P_{G}, P_{B}, P_{IR}) to merge into one transmission path, which the visible light beam and the invisible light beam have the same transmission path is provided by the light source unit 112′. In other words, the visible light beam and the invisible light beam provided by the light source unit 112′ share the light path P_{L}. As an exemplary, in FIG. 5, the green light beam is provided by the light source unit 112′; however, the disclosure is not limited thereto.

The lens unit 118 is located at light paths P_{L} of the visible light beam and the invisible light beam between the light source unit 112 and the image unit 114, and the lens unit 118 includes at least one optical lens. As the visible light beam and the invisible light beam provided by the light source unit 112 are projecting on the lens unit 118, the lens unit 118 adjusts transmission paths of the visible light beam and the invisible light beam toward the image source 114.

The image source 114 is located at light paths P_{L} of the visible light beam and the invisible light beam. As the visible light beam and the invisible light beam pass through the image source 114, the image source 114 converts the visible light beam into a visible image beam and converts the invisible light beam into an invisible image beam. In an embodiment, the image source 114, for example, includes a microdisplay panel.

The projection lens 116 is located at light paths P_{I} of the visible image beam and the invisible image beam. As the visible image beam and the invisible image beam pass through the projection lens 116, the projection lens 116 projects a visible image and an invisible pattern to a projection area PA located outside the optical engine 110.

The image capturing unit 120 captures an image having depth information from the projection area, in which the image having depth information is generated when the invisible image beam is projected onto an object from the projection area PA. Furthermore, before the image capturing unit 120 captures the image having depth information, the image capture unit 120 first captures a reference pattern, which the reference pattern is the invisible pattern being generated by projecting invisible image beam to the projection area PA. In an embodiment, the image capturing unit 120 can be, for example, a depth camera, a 3D camera having a multiple lenses, a combination of multiple cameras for constructing a three-dimensional (3D) image, or other image sensors capable of detecting 3D space information.

The processing unit 130 is electrically coupled to the optical engine 110 and the image capturing unit 120. The processing unit 130 receives the image having depth information and compares the reference pattern and the image having depth information to obtain a depth information of the object. According to the depth information of the object obtained from the image having depth information, the processing unit 130 determines an interactive event. In other words, the processing unit 130 performs image process and analysis for the image having depth information of the object, so as to detect a region of the object, and the processing unit 130 determines the interactive event according to the region of the object. Then, a status of the optical engine 110 is refreshed according to the interactive event. For example, the visible image projected by the optical engine 110 is updated according to the interactive event. The processing unit 130 is, for example, a device such as a central processing unit (CPU), a graphics processing unit (GPU), or other programmable microprocessor.

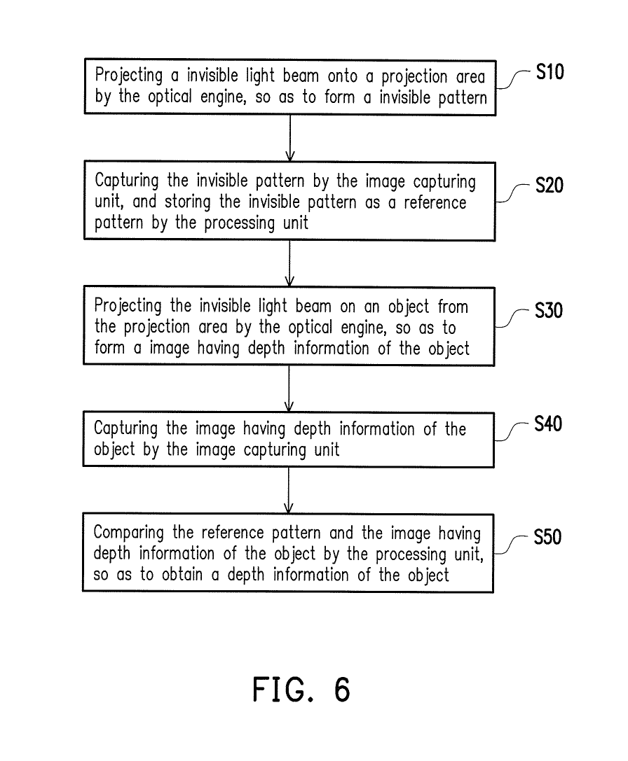

FIG. 6 is a flowchart illustrating an operation method of an interactive projector for determining a depth information of an object according to an embodiment of the present disclosure. The operation method described in the exemplary embodiment is adapted to the interactive projector 100 shown in FIG. 1, and the steps in the operation method are explained hereinafter with reference to the components in the interactive projector 100. The interactive projector 100 includes an optical engine 110, an image capturing unit 120 and a processing unit 130 electrically couple to the optical engine 110 and the image capturing unit 120. In step S10, an invisible light beam is projected to a projection area PA by the optical engine 110, so as to form an invisible pattern. In step S20, the invisible pattern is captured by the image capturing unit 120, and the invisible pattern is further stored as a reference pattern by the processing unit 130. In step S30, the invisible light beam is projected on an object from the projection area PA by the optical engine 110, and so as to form an image having depth information of the object. In step S40, the image having depth information of the object is captured by the image capturing unit 120. In step S50, the reference pattern and the image having depth information of the object are compared by the processing unit 130, so as to obtain a depth information of the object.

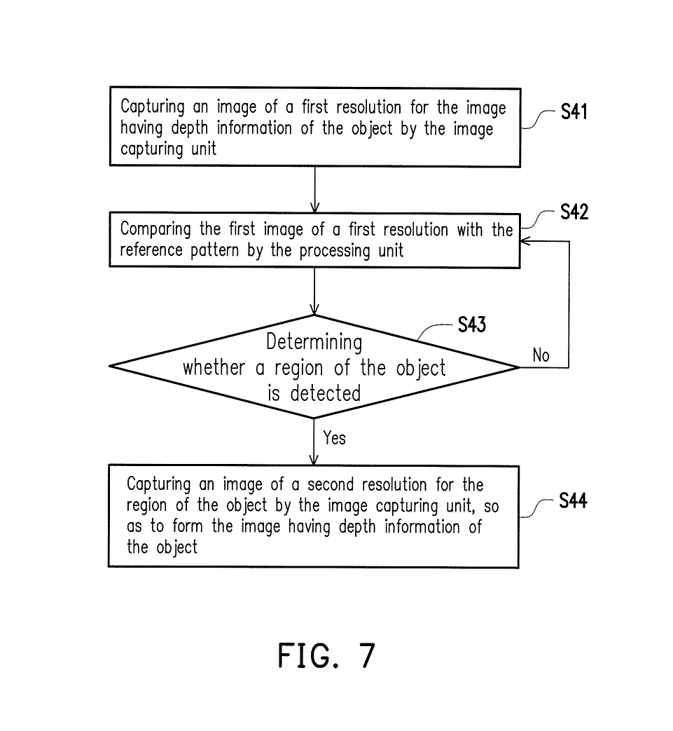

In an exemplary embodiment, as the image having depth information may be, for example, a dynamic pattern, the processing unit 130 divides the image having depth information into a first region of a first resolution and a second region of a second resolution, and the first resolution is less than the second resolution. Then, the step S40 may be divided into several steps S41, S42, S43, and S44. In FIG. 7 is a flowchart illustrating a method of capturing the image having depth information of the object according to an embodiment of the disclosure. An image of a first resolution for the image having depth information of the object is captured by the image capturing unit 120 (step S41). The first image of a first resolution is comparing with the reference pattern by the processing unit 130 (step S42). The processing unit 130 determines whether a region of the object is detected (step S43). If yes, an image of the region of the object is re-captured with a second resolution by the image capturing unit 120 (step S44); if not, step S42 is repeated until the region of the object is confirmed in step 43. In the embodiment, the image of the first resolution requires less computation relative to the image of the second resolution. In an embodiment, the reference pattern may be, for example, in a form of a dynamic pattern, which can be divided into several region with different resolutions.

To sum up, compared to the design of a conventional human-machine interactive device, the visible light source and the invisible light source are integrated to the light source unit of the interactive projector of the disclosure, it allows that the interactive protector projects an visible image (e.g., an user operation interface) and an invisible pattern (e.g., a reference pattern and an image having depth information of an object) onto the same projection area, which makes an image alignment between the depth camera and the projector is no needed, resulting in simple manufacturing processes, low manufacturing cost, and a Portable size.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An interactive projector comprising:
an optical engine, integrating a visible light source and an invisible light source and projecting a visible image via the visible light source and an invisible pattern via the invisible light source to a projection area;
an image capturing unit, capturing a image having depth information from the projection area, and the image being projected on an object via the invisible light source; and
a processing unit, electrically coupled to the optical engine and the image capturing unit, wherein the processing unit receives the image having depth information and determines an interactive event according to the image having depth information, and a status of the optical engine is refreshed according to the interactive event.

2. The interactive projector as claimed in claim 1, wherein the visible light source comprises a white light-emitting diode (LED), or a red LED, a green LED and a blue LED.

3. The interactive projector as claimed in claim 1, wherein the invisible light source comprises an infrared ray (IR).

4. The interactive projector as claimed in claim 1, wherein the optical engine, comprising:
a light source unit, integrating the visible light source and the invisible light source, and providing a visible light beam and an invisible light beam;
a image source, located on light paths of the visible light beam and the invisible light beam, and converting the visible light beam into a visible image beam and converting the invisible light beam into an invisible image beam; and
a projection lens, located on light paths of the visible image beam and the invisible image beam, and projecting the visible image and the invisible pattern to the projection area located outside the optical engine.

5. The interactive projector as claimed in claim 4, wherein the visible image beam and the invisible image beam are projected to form the visible image and the invisible pattern by passing through the projection lens.

6. The interactive projector as claimed in claim 4, wherein the optical engine further comprising:
a lens unit, located on light paths of the visible light beam and the invisible light beam, adjusting transmission paths of the visible light beam and the invisible light beam toward the image source.

7. The interactive projector as claimed in claim 4, wherein the light source unit further comprises a color wheel, at least one mirror, at least one dichroic mirror, or a combination thereof.

8. The interactive projector as claimed in claim 1, wherein the visible image comprises an user operation interface.

9. The interactive projector as claimed in claim 1, wherein the invisible pattern is a reference pattern being projected onto the projection area via the invisible light source.

10. The interactive projector as claimed in claim 9, wherein the processing unit compares the reference pattern and the image having depth information to obtain a depth information of the object for determining the interactive event.

11. The interactive projector as claimed in claim 10, wherein the image having depth information is a dynamic pattern, the processing unit divides the image having depth information into a first region of a first resolution and a second region of a second resolution, and the first resolution is less than the second resolution.

12. The interactive projector as claimed in claim 1, wherein the visible image projected by the optical engine is updated according to the interactive event.

13. An operation method of an interactive projector for determining a depth information of an object, the interactive projector comprising an optical engine, an image capturing unit and a processing unit, the operation method comprising:
projecting an invisible light beam onto a projection area by the optical engine, and so as to form an invisible pattern;
capturing the invisible pattern by the image capturing unit, and storing the invisible pattern as a reference pattern by the processing unit;
projecting the invisible light beam on an object from the projection area by the optical engine, and so as to form an image having depth information of the object;
capturing the image having depth information of the object by the image capturing unit; and
comparing the reference pattern and the image having depth information of the object by the processing unit, and so as to obtain a depth information of the object.

14. The operation method of an interactive projector for determining a depth information of an object as claimed in claim 13, wherein a method of capturing the image having depth information of the object comprises:
capturing an image of a first resolution for the image having depth information of the object by the image capturing unit;
comparing the first image of a first resolution with the reference pattern by the processing unit to detect a region of the object; and
capturing an image of a second resolution for the region of the object by the image capturing unit, and so as to foul′ the image having depth information of the object, and wherein the first resolution is less than the second resolution.

15. The operation method of an interactive projector for determining a depth information of an object as claimed in claim 14, wherein during comparing the reference pattern and the image having depth information of the object by the processing unit, the image of the first resolution requires less computation relative to the image of the second resolution.
